(19) United States
(12) Patent Application Publication
(10) Pub. No.: US 2005/0095548 A1
(43) Pub. Date: May 5, 2005

(54) Adaptable heating apparatus

(76) Inventor: Danny Gagnon, Laval (CA)

Correspondence Address: Brouillette Kosie Prince, 25th Floor, 1100 Rene-Levesque Blvd. West, Montreal, QC, H3B 5C9, CA

(21) Appl. No.: 10/952,877

(22) Filed: Sep. 30, 2004

Related U.S. Application Data
(63) Continuation-in-part of application No. 10/353,347, filed on Jan. 21, 2003, now abandoned.

(30) Foreign Application Priority Data
Jan. 22, 2002 (CA) 2,369,160

(51) Int. Cl. F27B 9/08

(52) U.S. Cl. 432/153

(57) ABSTRACT

The heating systems which are generally used to preheat large refractory surfaces in order to stack different layers of material normally used are either electrical heating plates or gas burners. In the present invention, the heating apparatus is made of one or many mattresses laid on the surface to be heated, the number of mattresses depending on the size of the area to be heated. The mattress is connected to one or many portable heating units equipped with a fan and a heat exchanger that inflate the mattress with warm air and create an air film between the mattress and the surface to be heated. The advantage of that apparatus is the lightness, the precision and the homogeneity of the temperature obtained at the specific surface.

This application is a continuation-in-part application of prior application Ser. No. 10/353,347, filed on Jan. 21^{st}, 2003.

### FIELD OF THE INVENTION

The present invention generally relates to heating apparatuses. More specifically, the present invention is concerned with a hot air heating apparatus that can preheat refractory material.

### BACKGROUND OF THE INVENTION

It is known to those of ordinary skill in the art that a refractory material must get to a predetermined temperature to achieve its optimal configuration, and that obtaining this temperature and its homogeneity are key elements for the viability of the refractory material.

In some existing techniques, the preheating of a refractory material is done by using heating plates against the surface of the material (radiation).

However, these techniques involving heating plates do not give a constant heating as the plate must be hotter that the desired temperature. Also, the heavy weight and the rigidity of the metal plates make their handling much more difficult.

For instance, to get a surface heated at 40° C., a plate is generally heated at 150° C., and the only way to control the temperature at the surface of the material is the heating time.

Another method which may be used includes the building of a temporary tent. A unit heater is installed on the refractory surface and heats the space covered by the tent.

However, this method involves a very long heating time, since all the space under the tent must be heated, instead of heating only the desired surface. Also, the heating homogeneity is not constant.

The heating apparatus of the present invention reduces the air volume to be heated (mattress) and produces a generally constant and uniform heat that allows the control of the temperature of the desired refractory surface, and its heating time.

### OBJECTS OF THE INVENTION

An object of the present invention is to provide a heating apparatus which is light, easy to manipulate and efficient to help generate and maintain the homogeneity of the temperatures selected to heat or cure a refractory material.

### SUMMARY OF THE INVENTION

More specifically, in accordance with the present invention, there is provided an apparatus for heating a refractory material, including a mattress including a chamber and a permeable wall including openings, the permeable wall being so configured and sized as to be positionable adjacent to the refractory material; the apparatus further including a heated fluid source supplying assembly so configured and sized as to supply heated fluid source to the chamber of the mattress; whereby upon operation of the heated fluid source supplying assembly, a portion of the heated fluid source supplied to the chamber is able to diffuse through the mattress via the openings to heat the refractory material.

There is also provided an apparatus for heating a surface of refractory material including at least one mattress, each mattress being adapted to be laid on the surface of the refractory material and including a chamber and at least one permeable wall; the apparatus further including at least one heated fluid source supplying assembly connected to the at least one mattress, each of the at least one heated fluid source supplying assembly including a heat exchanger so configured and sized as to heat a fluid source; the at least one heated fluid source supplying assembly further including a fan so configured and sized as to blow the fluid source from the at least one heated fluid source supplying assembly to the chamber of the at least one mattress; whereby upon operation of the heated fluid source supplying assembly, the heated fluid source diffuses via the permeable wall and is able to generate a film of fluid source between the at least one permeable wall and the surface of refractory material.

The above and other objects, advantages and features of the present invention will become more apparent upon reading of the following non-restrictive description of illustrative embodiments thereof, given by way of example only with reference to the accompanying drawings.

### BRIEF DESCRIPTION OF THE FIGURES

In the appended drawings:

FIG. 1 is a perspective view of an adaptable heating apparatus according to an illustrative embodiment of the present invention; and

FIG. 2 is a sectional view taken along line 2-2 in FIG. 1.

### DETAILED DESCRIPTION

Generally stated, the present invention relates to a heating apparatus 20 which is generally movable and which adapts to preheat a surface of a material, such as for example refractory material, with a fluid source.

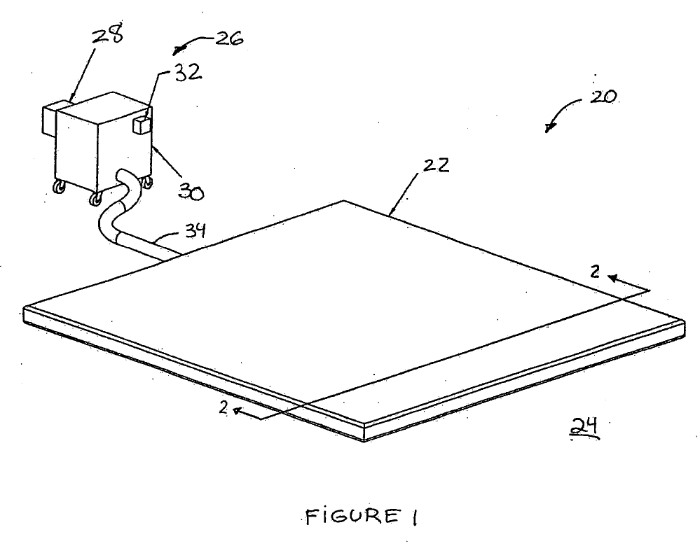

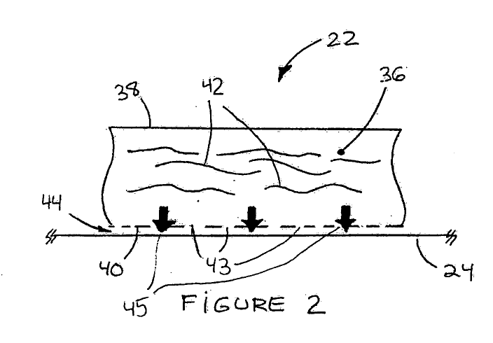

As seen in FIGS. 1 and 2, the heating apparatus 20 is made of one or many mattresses 22 (only one shown) so configured as to be laid on the surface of refractory material 24 to be heated or cured. The mattress 22 includes one or many impermeable wall 38 and one or many permeable wall 40 and is generally deformable and or inflatable.

The mattress 22 is generally made from fabric, cloth or fiber members selected according to their physical and chemical properties. A person skilled in the art will easily understand that the selected material for the mattress may alternatively be provided with various types of coatings, and may further alternatively include various types of components, such as for example, metallic, elastomeric or plastic components enhancing the wearing, isolating, radiating and deformation properties of the mattress 22. Further, the mattress 22 may be made from hard wearing, though generally light cloth.

The permeable wall 40 of the mattress 28 includes a plurality of openings 43 and defines an inner chamber 36 altogether with the impermeable wall 38. The openings 43 have a size and shape which are so configured as to allow for a fluid source inside the chamber 36 to exit the mattress 22 toward the refractory material 24 to be heated. The configuration of the openings 43 generally further influences the diffusion rate of the fluid source through the permeable wall 40.

The openings 43 are further generally positioned with respect to the permeable wall 40 in accordance with a pattern (not shown) so configured as to optimally and uniformly provide a heating temperature to the refractory material 24. The pattern is generally selected according to the size of the refractory material 24 to be heated and according to the circulation of fluid source through the mattress 22 which is desired, as will be further explained hereinbelow. Alternatively, the openings 43 are provided with grommets (not shown) to minimize the fraying at the periphery of the openings 43.

The impermeable wall 38 is generally significantly impermeable to the fluid source inflated or already contained inside the chamber 36 to help-build a fluid pressure during inflation inside the mattress 22 and to help maintain the operational configuration of the mattress 22.

The number of mattresses 22 used in the heating apparatus 20 generally depends on the size of the refractory material 24 to be heated. Generally, each mattress 22 is connected to one or many portable heating units or heated fluid source supplying assembly 26 via a hose 34 which may be flexible.

The heating unit 26 includes a fan 28 and a heat exchanger 30 which are so configured as to inflate or fill the mattress 22 with the fluid source, such as for example hot or warm air, and to generate an air film 44 between the mattress 22 and the refractory material 24 to be heated, as will be further described hereinbelow. Alternatively, when more than one heating units 26 are used, they may be altogether connected in series or in parallel to at least one mattress 22.

The fan 28 of each portable heating unit 26 is so configured as to blow air into the heat exchanger 30 which may be electrically operated. The fan 28 is generally installed before or upstream from the heat exchanger 30 with respect to air flow direction into the apparatus 20. Each heating unit 26 may further be provided with a control 32 for the blowing speed and for the temperature, such that these heating units 26 can be independently controlled according to the temperature of each mattress 22.

In operation, the mattress 22 is filled with hot or warm air under pressure coming from the heat exchanger 30. As a portion of the air (schematically identified as 42) inflates or maintains the operational-configuration of the mattress 22, another portion of air (see arrows 45) is generally diffused through the permeable wall 40 of the mattress 22, via the openings 43 and toward the refractory material 24.

This phenomenon has the effect of generating a film 44 of air between the permeable wall 40 and the refractory material 24 to be heated, such that the mattress 22 “floats” adjacent to the refractory material 24 to be heated. The film 44 of air is generally at a constant temperature which helps to provide a generally uniform temperature during curing or heating of the refractory material.

The thickness of the film 44 is generally a function of a plurality of conditions such as for example the size of the openings 43, the air pressure maintained in the chamber 36, the size, the weight and the material of the mattress 22 and the type of refractory surface 24 and its heated state.

As stated hereinabove, the heating unit 26 generally uses the convection or diffusion as a heating medium (ventilation), and the selected material of the mattress 22 is generally so configured as to help uniformly maintain the temperature between the mattress 22 and the surface 24 to be heated.

While the apparatus 20 is in operation, the mattress 22 has an overall thickness which has been chosen so as to provide an adequate insulation to further help maintain the heated material at a generally constant temperature.

During earlier trials of the prototype on a surface 24 to be heated of about 3 meters by 4 meters (about 10 feet by 13 feet), the differential of temperature obtained for a target of 40° C. was 5° C. Therefore, this apparatus 20 allows to obtain a targeted temperature within the tolerance as per the specifications of the refractory material supplier. However, less favorable results can happen in the case where the outside temperature is below 2° C.

Although the present invention has been described hereinabove by way of an example thereof, it can be modified, without departing from the spirit and nature of the subject invention as defined in the appended claims.

1. An apparatus for heating a refractory material, comprising:
a) a mattress comprising a chamber and a permeable wall including openings, said permeable wall being so configured and sized as to be positionable adjacent to the refractory material; and
b) a heated fluid source supplying assembly so configured and sized as to supply heated fluid source to said chamber of said mattress;
whereby upon operation of said heated fluid source supplying assembly, a portion of the heated fluid source supplied to said chamber is able to diffuse through said mattress via said openings to heat the refractory material.

2. An apparatus as claimed in claim 1, wherein said mattress is deformable.

3. An apparatus as claimed in claim 1, wherein said heated fluid source supplying assembly includes a heat exchanger which heats the fluid source.

4. An apparatus as claimed in claim 1, wherein said heated fluid source supplying assembly includes a fan so configured as to blow the fluid source from said heated fluid source supplying assembly to said chamber.

5. An apparatus as claimed in claim 1, wherein said heated fluid source supplying assembly is connected to said mattress by at least one hose.

6. An apparatus as claimed in claim 1, wherein said heated fluid source supplying assembly is portable.

7. An apparatus as claimed in claim 1, wherein said heated fluid source supplying assembly is electronically operated.

8. An apparatus as claimed in claim 1, wherein said heated fluid source supplying assembly further includes a temperature control.

9. An apparatus as claimed in claim 4, wherein said heated fluid source supplying assembly further includes a blowing speed control.

10. An apparatus as claimed in claim 1, wherein said heated fluid source supplying assembly includes a heat exchanger and a fan which is upstream of said heat exchanger.

11. An apparatus as claimed in claim 5, wherein said at least one hose is flexible.

12. An apparatus as claimed in claim 1, wherein said permeable wall is made of hard-wearing cloth.

13. An apparatus as claimed in claim 1, wherein said mattress includes more than one mattress.

14. An apparatus as claimed in claim 1, wherein said permeable wall includes more than one permeable wall.

15. An apparatus as claimed in claim 1, wherein said heated fluid source supplying assembly includes more than one heated fluid source supplying assembly.

16. An apparatus as claimed in claim 1, wherein said fluid source is air.

17. An apparatus for heating a surface of refractory material, comprising:
a) at least one mattress, each mattress being adapted to be laid on the surface of the refractory material and comprising a chamber and at least one permeable wall;
b) at least one heated fluid source supplying assembly connected to said at least one mattress, each said at least one heated fluid source supplying assembly comprising:
i. a heat exchanger so configured and sized as to heat a fluid source;
ii. a fan so configured and sized as to blow the fluid source from said at least one heated fluid source supplying assembly to said chamber of said at least one mattress;
whereby upon operation of said heated fluid source supplying assembly, the heated fluid source diffuses via said permeable wall and is able to generate a film of fluid source between said at least one permeable wall and the surface of refractory material.

18. An apparatus as claimed in claim 17, wherein said permeable wall includes openings so configured and sized as to allow the heated fluid source to diffuse between said at least one permeable wall and the surface of refractory material.
